(19) United States
(12) Patent Application Publication
(10) Pub. No.: US 2010/0049800 A1
(43) Pub. Date: Feb. 25, 2010

(54) Facilitated Help With Program Function From Experienced Users

(75) Inventors: Elizabeth Hatfield, Cary, NC (US); Eldon Gale Nelson, Rochester, MN (US); Emi Kondo Olsson, Germantown, NY (US)

Correspondence Address: IBM-Rochester c/o Toler Law Group, 8500 Bluffstone Cove, Suite A201, Austin, TX, 78759, US

(73) Assignee: INTERNATIONAL BUSINESS MACHINES CORPORATION, Armonk, NY (US)

(21) Appl. No.: 12/194,699

(22) Filed: Aug. 20, 2008

(51) Int. Cl. G06F 15/16

(52) U.S. Cl. 709/204

(57) ABSTRACT

Instructional information pertinent to a program application is automatically solicited and communicated from a user experienced within an application's function. Recorded interaction with the application by experienced users may be maintained within a database. A request for help may be matched to experienced users in the database based on their recorded usage. The matching process may also account for other factors, such as the physical location or preferred contact method of the experienced users. The experienced user may be selected for contact, and may have an opportunity to accept or decline the offer to help the requesting user. Communication information may be exchanged to facilitate the dispersal of the instructional information.

### FIELD OF THE INVENTION

The present invention relates generally to computing systems, and more particularly, to managing instructional information relating to using program functions executed by computing systems.

### BACKGROUND OF THE INVENTION

Requirements placed on computer functions constantly expand to meet new and varied work tasks. Software designers, in-turn, continue to add a greater number of sophisticated features to meet the demand. As a result, computer software programs often incorporate a seemingly overwhelming number of auxiliary features. Many of these features are poorly explained in the instructions, and/or are complex enough to discourage the user. Even experienced software users, when unfamiliar with a specific software function, may resort to surfing between menus in an effort to elicit a desired result. Alternatively, some users may develop inefficient and complicated workarounds to affect the result, simply because they are unaware that an easier and more efficient method exists. Cumulatively, a prevalence of such practices within an organization can result in a substantial waste of time and resources.

Help desk personnel are one option for those seeking help. However, such persons do not necessarily have an expertise in the most detailed software functions. Other available solutions include various types of help wizards, which generally assist software users with predetermined tasks. Basic context-based help wizards are accessed by selecting an object on the screen and then clicking a help command. On-screen help information is then provided, discussing the attributes of the object selected. More probabilistic-type help wizards have also been developed. Such wizards employ complex reasoning methods to predict individual user needs, intentions, or goals based on the automated tracking of a user's past interactions with the software. In an effort to further tailor this resource to the individual, programs have been developed to track the number of times a user has sought help with a particular function, and correspondingly adjust the amount of help information offered. Unfortunately, help wizards require significant resources to design, and often the particular function with which the user needs assistance is unavailable.

Depending on the number of software users within a particular organization, individual experience with particular program functions may vary widely from user to user. Unbeknownst to a user experiencing difficulties, there may be multiple users within their organization having considerable expertise with that particular software function. The fact that an experienced user's knowledge and expertise is unknown, and consequently untapped, remains a significant inefficiency to the organization as a whole. Discouragingly, users are unable to learn from their own organization's internal software experts.

Therefore, what is needed is an improved way to harness and efficiently distribute instructional knowledge possessed by members of a workplace and pertaining to a computer application function.

### SUMMARY OF THE INVENTION

The present invention provides an improved computer implemented method, apparatus and program product for harnessing and efficiently distributing instructional knowledge possessed by members of a workplace and pertaining to a computer application function. Aspects of the invention may facilitate the communication of instructional information relating to a computer function, such as automatically determining in response to a user request for the above mentioned instructional information, an experienced user based upon usage of the computer function by that experienced user. Communication of the instructional information from the experienced user to the requesting user may also be facilitated.

Embodiments consistent with the invention may automatically record usage data associated with the usage of a computer function by an experienced user. Determining the experienced user may comprise determining the usage of the computer function by the experienced user based upon the number of times, and/or how recently the experienced user has accessed the computer function. Aspects of the invention may also define an experienced user in relation to the proximity of the experienced user to the requesting user, and relative availability of the experienced user and other criteria.

Embodiments consistent with the invention may assemble the usage data including storing it in a database in association with a group of experienced user(s). The group may be configured to include one or more experienced users. Aspects of the invention further comprise receiving the request for the instructional information from the requesting user. Embodiments of the invention may query the database, including usage data, pertaining to the usage of the computer function by the experienced user.

Aspects of the invention may display to the user requesting the instructional information results data comprising at least the experienced user. The computer implemented method may further comprise prompting a selection of the results data by the user requesting the instructional information to the display.

Embodiments of the present invention may facilitate the communication of the instructional information by communicating contact information to at least one of the experienced user and the user requesting the instructional information. Facilitating the communication of the instructional information may further comprise communicating the instructional information to the user requesting the instructional information by using a communication mechanism selected from a list consisting of at least one of: electronic mail, instant messaging, voice chat, electronic data transfer, telephone-based and web-based communications. The experienced user may be enabled to accept an invitation to provide the requested instructional information. Communication of the instructional information to the requesting user may be declined by the experienced user. Aspects of the invention may prompt the selection of another experienced user by the requesting user.

Embodiments of the present invention may include an apparatus comprising a memory, and program code residing in the memory. The apparatus may also comprise a processor in communication with the memory and configured to execute the program code to determine, in response to a user request for instructional information pertaining to a computer function, an experienced user based upon usage of the computer function by the experienced user, and to facilitate communication of the instructional information from the experienced user to the requesting user. The memory may include a database storing usage data associated with the usage of the computer function by the experienced user

A program product consistent with aspects of the invention may comprise a program code configured to determine, in response to a user request for instructional information pertaining to a computer function, an experienced user based upon usage of the computer function by the experienced user, and to facilitate communication of the instructional information from the experienced user to the requesting user. The program product may also consist of a computer readable medium bearing the program code.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 shows a computer system configured to facilitate the communication of instructional information regarding a program application from an experienced user in a manner that is consistent with the underlying principles of the invention.

FIG. 2 shows a block diagram representative of the system components on an application server or other computing system as could be implemented within the system of FIG. 1 for locating and communicating instructional information relating to a computer function to a requesting user in accordance with the underlying principles of the present invention.

FIG. 3 shows an exemplary screen shot that includes a graphical user interface such that may be generated by the system of FIG. 2 for facilitating the sharing of instructional information pertaining to a program function in a manner that accords with the underlying principles of the present invention.

FIG. 4 shows a graphical user interface that may be displayed to a user in response to a user initiating a help request using program code executed by the system of FIG. 2 in accordance with the underlying principles of the present invention.

FIG. 5 shows a chart having usage data associated with users of a function of an application supported in the system of FIG. 2 in accordance with the underlying principles of the present invention.

FIG. 6 shows a flowchart having steps executable by the system of FIG. 2 for facilitating the communication of instructional information relevant to a computer function to a requesting user from an experienced user in accordance with the principles of the underlying invention.

### DETAILED DESCRIPTION

Embodiments consistent with the underlying principles of the present invention may automatically solicit and communicate instructional information pertinent to a program application function from a user experienced with the function. Recorded interaction with the function by experienced users may be maintained within a database. A request for help may be matched to experienced users in the database based on their recorded usage. The matching process may also account for other factors, such as the physical location or preferred contact method of the experienced users. The experienced user may be selected for contact, and may have an opportunity to accept or decline the offer to help the requesting user. Communication information may be exchanged to facilitate the dispersal of the instructional information.

Embodiments consistent with the underlying principles of the present invention enable users to contact experts in the area of certain individual application function. The automated direction to such experienced users facilitates the expedient and efficient location and acquisition of the needed learning knowledge. Aspects of the invention may track and document individual usage within an organization of a particular function of a program. Such usage information may be automatically matched, along with other criteria, to a new user request. The matched request and usage data may facilitate communications between a user requiring help and a former user having appropriate experience with the complex function.

Experienced users identified with the usage data may have the opportunity to accept or decline participation. For instance, an experienced and identified user may accept or decline a request for help that is automatically generated and sent to them.

Embodiments may send usage data of the application functions used by a user to a group wide database tracker. When a user has a problem with a particular function, context sensitive help buttons may appear. Associated processes may lookup the usage for that particular function. The system may provide an interface to ask the users experienced with that particular function for help. Embodiments consistent with the invention may thus provide a way for candidates to help by figuring out who might be best to assist a less experienced user.

One criterion used to select the most appropriate, experienced user may include the respective, physical locations of both the requesting and experienced users. A relatively close proximity to one another may enable face-to-face and/or hands-on communication between the parties for added efficiency. Another criterion used for the selection process may include how often the experienced user was exposed to the function of the application. How recently the experienced user used the function may also comprise part of the algorithm that is programmatically executed to determine the selection.

User defined criteria may also play a role in the selection process. For example, a user may designate a preference for help from a particular department of the group, and/or an experienced user who can respond within a relatively short duration, i.e., relating to user availability and response time. Such availability may relate to the willingness and capability to respond using an instant messenger tool, for example. Communications facilitated by program code with the experienced personnel may be accomplished using instant messaging, telephone, electronic mail (email), voice chat, or any other number of known communication methods.

Where so configured, the usage of the application data may be shared only with a certain company or group to make the request for help conducive to the goals of the company. The data and request for help may extend to a larger community if the organization decides such sharing of the data is appropriate. Embodiments may be used to facilitate better help service by categorizing help personnel at a granularity that is better than at the application level.

In one example, a user may want to know how a mail-related wizard works. The user may attempt to access a local help tool. A local help button may appear as an optional display for selection by the user, and may be presented to the user within a certain function of the program.

More specifically, a graphic user interface (GUI) may appear and provide the requesting user with a sampling of users who have used the particular function recently and/or with some frequency. Such a GUI may display the name of the experienced users, along with any relevant usage data. Such usage data may relate to how recently the person used the function. Other information may indicate how many times the user has used the particular function. Other information may relate to the availability of the user to respond to a request from a user, or their contact preferences.

Where desired, a symbol may be used to efficiently communicate to a user the experienced level of a displayed experienced user. For example, a gold star may be displayed in connection with someone who has used the function over 100 times, while a yellow star may indicate that the displayed user has used the function more than 20 times, but less than 100. After selecting the local help button, an interface may appear that shows the user who in their group may have performed that particular function according to preset criteria. As will be appreciated by one of skill in the art, any number of other criteria may be indicated in such a display as may be helpful to a requesting user.

Embodiments consistent with the underlying principles of the present invention may provide users a way of receiving help regarding a particular function of a program. Aspects of the invention may provide such help by matching a request for information with a person having known experience with the particular function. The experienced user may accept or decline the request for information.

Embodiments consistent with the invention may include a software program that runs in the background and records usage information regarding a user's experience with the function. For instance, the program may track information relating to the frequency and most recent use of the program function by the user. The users of the program may have a tally of how many times a certain function is called by them. Their usage data of the function names may be stored in a central server.

As such, embodiments consistent with the invention may address problems faced by administrators/users and associated with the prolific addition of features to programs. A network may host a number of such complex programs. Embodiments consistent with the invention minimize the need to maintain an exhaustive knowledge of the intricacies of each program. Many such programs include multiple wizards and other features useful in helping users to access program tools. Aspects of the invention may automatically locate users having experience with auxiliary features that are often undocumented or remain complex enough to discourage users. While help desk personnel may have a general working knowledge of an application, expertise provided by embodiments of the invention may extend to the most detailed and updated functions of a programmatic tool. Context help wizards may assist with predetermined tasks. However, aspects of the invention reduce the resource and design burden associated with such wizards, while assisting more obscure functions that are impractical to include in wizard programming.

Aspects of the invention may provide an efficient way of allowing other people within a definable group to provide help to those in need. Embodiments may be context sensitive in the sense that they provide contextual information, i.e., instructional information, about the program function or link in which a user is interested. Such usage information may be stored in the database. When a user submits a request for help, program code may search the database using an algorithm that determines an optimal match. Different criteria may be used by the algorithm to determine the most appropriate, experienced user. A list of potential candidates may be presented to the requesting user. The user may be prompted to select an experienced user from the presented list. This may allow a user with a personal relationship with a particular experienced user to select accordingly. The selected experienced user may then be prompted to accept or decline the request to help. The program code may then present the requesting user with a phone number or other contact information associated with the willing, experienced user.

In some embodiments, the program code may cross reference other lists to automatically determine the existence of a previous relationship. User defined preferences may be preset to steer an experienced user selection process.

The determination process may be mathematically weighted in that certain criteria may be worth more than other criteria. For instance, use by an experienced user of the program function within the last week may be weighted more than similar experiences dated more than a month ago. A user located in the same building may receive a higher score than one located in another city. Program code consistent with the invention may determine the more appropriate experienced user(s) based upon the weighted criteria.

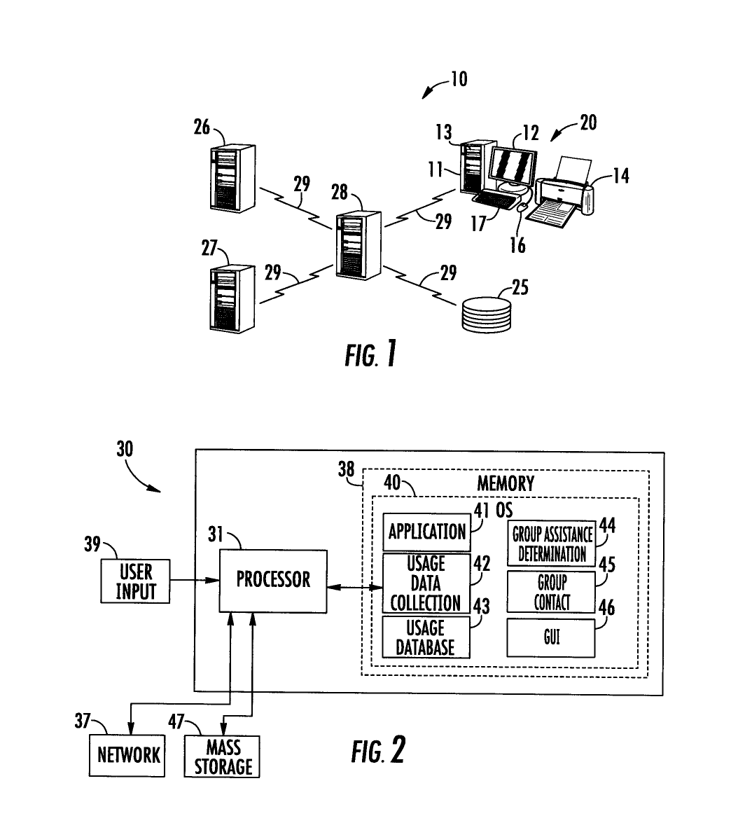

Turning to the Drawings, wherein like numbers denote like parts throughout the several views, FIG. 1 illustrates a computer system 10 configured to broker the communication of instructional information regarding a program application from an experienced user in a manner that is consistent with embodiments of the invention. The computer system 10 is illustrated as a networked computer system including one or more systems, e.g., client or server computers, 20, 24, 26, 27 and 30 coupled to an application server 28 through a network 29.

The application server 28 may comprise a computer or computer program that provides services to other programs (and their users) in the same or another computer. In one embodiment, application server 28 may include a software engine that delivers applications to client computers or devices, typically through the network 29 and using, for instance, HyperText Transfer Protocol. An exemplary application server 28 may extensively use server-side dynamic content and perform frequent integration with database engines.

Application servers may run on many platforms, and the term may apply to different software applications. For instance, an application server consistent with the invention may pertain to servers of web-based applications, such as integrated platforms for e-commerce, content management systems and web-site builders.

The network 29 may represent practically any type of networked interconnection, including, but not limited to, local area, wide area, wireless, and public networks, including the Internet. Moreover, any number of computers and other devices may be networked through the network 29, e.g., multiple additional servers. Furthermore, it should be appreciated that aspects of the invention may be realized by stand-alone, handheld, and associated devices.

Client computer system 20, which may be similar to servers 26, 27, 28, may include one or more processors. The system 20 may also include a number of peripheral components, such as a computer display 12 (e.g., a CRT, an LCD display or other display device), and mass storage devices 13, such as hard, floppy, and/or CD-ROM disk drives. As shown in FIG. 1, the computer system 20 also includes a printer 14 and various user input devices, such as a mouse 16 and keyboard 17, among others. Computer system 20 operates under the control of an operating system, and executes various computer software applications, programs, objects, modules, etc. Various applications, programs, objects, modules, etc. may execute on one or more processors in server 28 or other computer servers 26, 27, such as a distributed computing environment.

It should be appreciated that the various software components may also be resident on, and may execute on other computers coupled to the computer system 10. Specifically, one particularly useful implementation of an execution module consistent with the invention is executed in a server such as the WebSphere Application Server available from International Business Machines Corporation (IBM). It should be appreciated that other software environments may be utilized in the alternative.

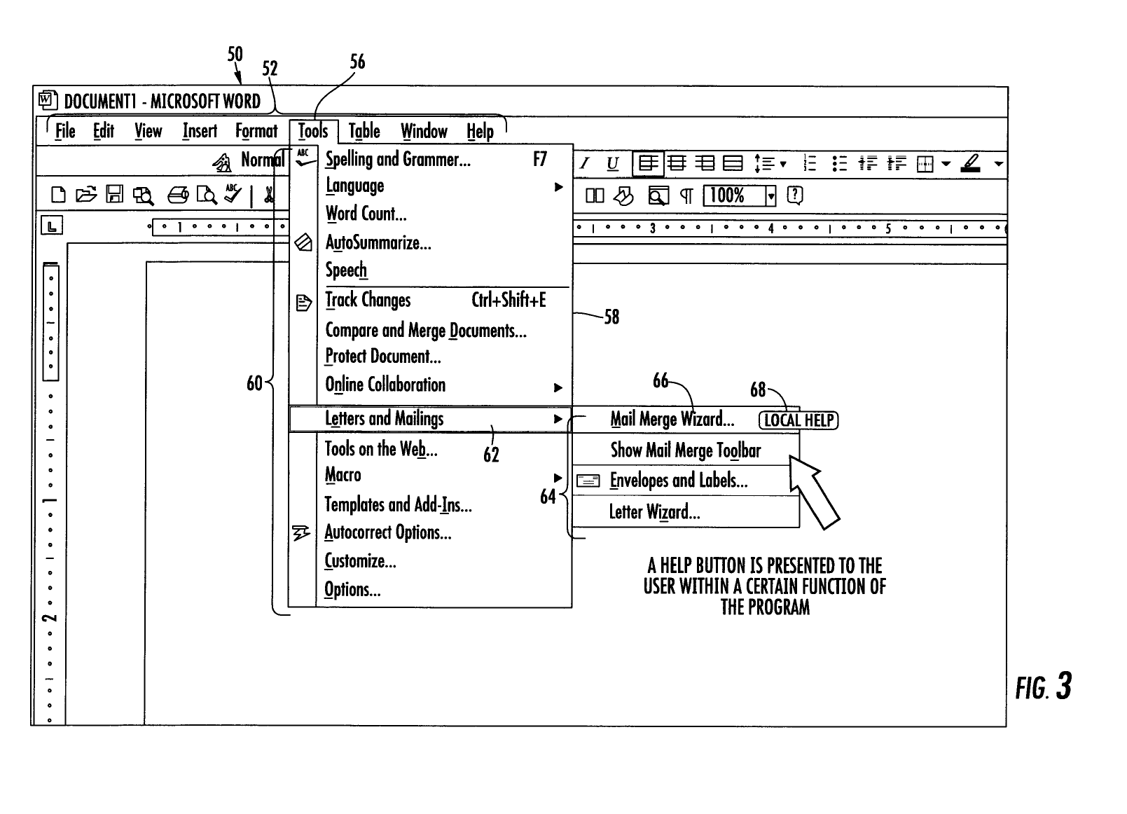

FIG. 2 shows a computer system 30 such as may have application within the system 10 of FIG. 1 for locating and communicating instructional information relating to a computer function to a requesting user in accordance with the underlying principles of the present invention. A processor 31 is shown coupled to a memory 38, as well as to several inputs and outputs. For example, user input 39 may be received by processor 31, e.g., through a communication port, among other input devices. Additional information may be passed between the application server 30 and other computer systems in a networked computer system 30 via the network 37. Additional information may be stored and/or received from mass storage 47. The processor 31 also may optionally output data to a computer display (not shown). The processor 31 may additionally interface with a web interface, among many other components. It should be appreciated that the application server 30 includes suitable interfaces between the processor 31 and each of the server's components, as is well known in the art.

An operating system 40 may reside in the memory 38, and is configured to execute program code on processor 31. As shown in FIG. 2, the operating system 40 may execute one or more functions, including an application function 41, usage data collection 42, usage database 43, group assistance determination 44, group contact 45, and/or graphical user interface (GUI) 46. While shown in FIG. 2 as residing within the memory 38 and operating system 40, each function 41, 42, 43, 44, 45, 46 may comprise a portion of a separate computer in another embodiment. Furthermore, any of the operating system 40, application function 41, usage data collection 42, usage database 43, group assistance determination 44, group contact 45, and/or GUI 46 may at different times reside in whole or in part in any of the memory 38, mass storage 33, network 29, or within registers and/or caches in processor 31.

In one embodiment consistent with the invention, the application function 41 may include a particular aspect of a much larger program. In another embodiment, a program function 41 may include an entire program/application having multiple smaller programmatic components. The usage data collection application 42 may transparently, e.g., in the background, or otherwise, collect user data pertaining to one more applications 41. Such usage data may be maintained within the usage database 43, which may partially reside in multiple local and remote memories.

The group assistance determination program 44 may include a program that considers one or more criteria to determine the most appropriate individual within an organization to provide help to a requesting user. The group contact program 45 may include a program that facilitates the passing of contact information or otherwise provides a mechanism for facilitating communication between the requesting and the experienced users. A GUI 46 typically includes a user interface that allows individuals to interact with a computer through the use of graphical icons, visual indicators and text based programmatic navigators.

Those skilled in the art will recognize that the exemplary environments illustrated in FIGS. 1 and 2 are not intended to limit the present invention. Indeed, those skilled in the art will recognize that other alternative hardware environments may be used without departing from the scope of the invention.

In general, the routines executed to implement the illustrated embodiments of the invention, whether implemented as part of an operating system or a specific application, program, object, module or sequence of instructions, may be referred to herein as computer programs, algorithms, or program code. The computer programs typically comprise instructions that, when read and executed by one or more processors in the devices or systems in computer system 10, cause those devices or systems to perform the steps necessary to execute steps or elements embodying the various aspects of the invention.

Moreover, while the invention has and hereinafter will be described in the context of fully functioning computer systems, those skilled in the art will appreciate that the various embodiments of the invention are capable of being distributed as a program product in a variety of forms. The invention applies equally regardless of the particular type of computer readable signal bearing media used to actually carry out the distribution. Examples of signal bearing media comprise, but are not limited to recordable type media and transmission type media. Examples of recordable type media include volatile and non-volatile memory devices, floppy and other removable disks, hard disk drives, magnetic tape, and optical disks (CD-ROMs, DVDs, etc.). Examples of transmission type media include digital and analog communication links.

FIG. 3 shows an exemplary screen shot 50 that includes a GUI 50 such that may be generated by the system 30 of FIG. 2 for facilitating the sharing of instructional information pertaining to a program function in a manner that accords with the underlying principles of the present invention. The GUI 50 includes several headings 54 to help steer a user's accessibility to the various functions of the program associated with the GUI 50. The GUI 50 may comprise an interface for a program having multiple functions. The user may select a particular function 56 for further examination.

In response to the selection of the function 56, a number of additional functions 60 may be presented to the user in a drop down window 58. Selection of a particular function 62 of the displayed function 60 may prompt the display of even more functions 64 particular to the selective function 62. Within the displayed function 64, the user may be presented with the opportunity of selecting a function 66 of particular interest. Accompanying the display of the function 66 may be a help button 68 in accordance with an embodiment of the present invention. The help button 68 may initiate a computer process to locate and deliver personal, experienced assistance with the function 66 from within a member of a predetermined group of users.

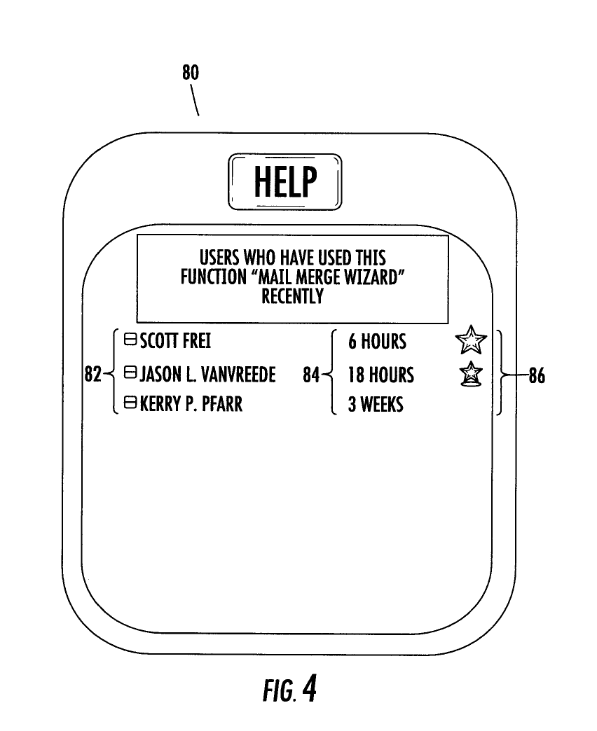

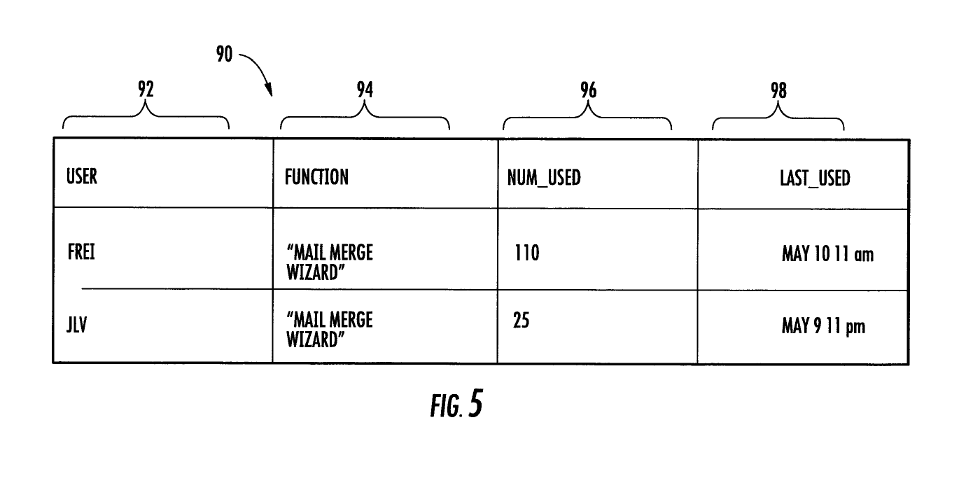

FIG. 4 shows a GUI 80 that may be displayed to a user in response to a user initiating a help request using program code executed by the system 30 of FIG. 2 in accordance with the underlying principles of the present invention. The GUI 80 includes a list of users 82 who may have the most relevant experience with the function with which the user requires assistance, as determined by the program code. While other criteria may alternatively or additionally be displayed, the exemplary GUI 80 shows the number of hours 84 each experienced user 82 has been exposed to the program function. Symbols 86 may also be included in the GUI 80 for ease of user reference. Such symbols may efficiently communicate meaningful data to the requesting user that pertains to the qualification or other appropriateness of an experienced user.

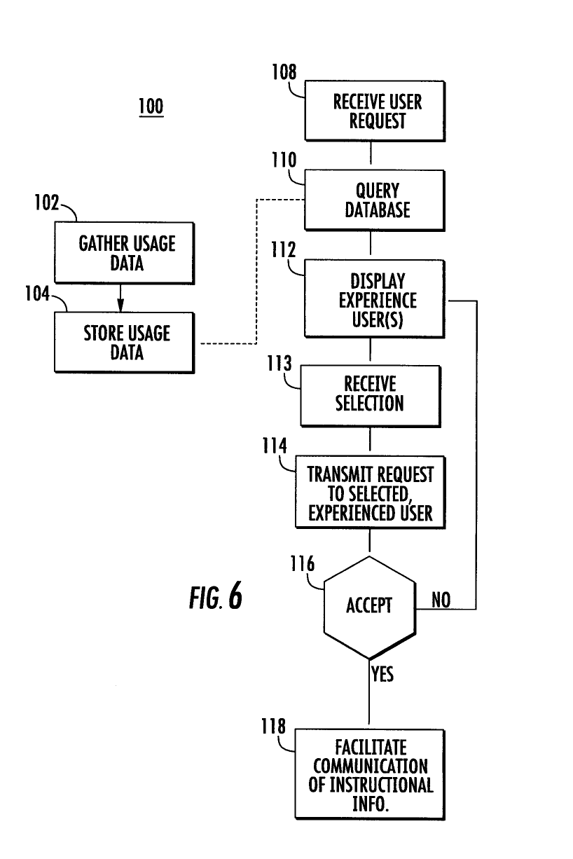

FIG. 5 shows a chart 90 having columns 92, 94, 96, 98 associated with experienced users' activity relating to a function of an application 41. More particularly, the chart 90 includes a column of experienced users 92. The chart 90 also shows recorded usage information associated with the column of experienced users 92 and a function listed in column 94. Another column 96 of the chart 90 includes usage information that corresponds to a number of minutes used for each experienced user in the column 92. Another exemplary column 98 of usage data includes a date corresponding to the user's most recent use of the application function. One skilled in the art will appreciate that another chart consistent with embodiments of the invention may include any other number of usage data and other criteria, including the relative location and/or availability of a respective user.

FIG. 6 shows a flowchart 100 having steps executable by the system 30 of FIG. 2 for facilitating the communication of instructional information relevant to a computer function to a requesting user from an experienced user in accordance with the principles of the underlying invention. A data gathering portion of the flowchart 100 may correspond to a period of time where experienced users access program resources or other functions. Turning more particularly to the steps of the flowchart 100, program code 42 may transparently collect usage data at block 102.

Exemplary usage data may include information pertaining to a user's interaction with a function. The usage data may be recorded whenever a user accesses a particular resource or other function. The application 41 may comprise most any function executable by a processor. Some applications may include multiple functions. In one embodiment, usage data may include information pertaining to the appropriateness of a user for responding to a request for help. Such data may relate to the proximity of the user to the requester, their respective availability, or nearly any other criteria affecting their potential for most efficiently responding to the query for help. Usage data pertinent to multiple applications and/or functions may be concurrently gathered at block 102.

The usage data may be stored at block 104 within a database 43. The usage data may be stored within the database 43 in such a manner that the data may be readily recalled and manipulated according to weighted criteria or other algorithmic manipulation.

The database 43 may be queried at block 110 of FIG. 6. That is, after a user initiates at block 108 a request for help pertaining to a particular function 41, program code 44 may apply any mathematical weights associated with pertinent criteria to determine one or more experienced users.

The system 30 may display at block 112 the list of experienced users. The display 80 may include a list of multiple experienced users, as well as their relevant experience or other qualifying or desirable attributes.

Where so configured, the system 30 may prompt and receive at block 113 from the requesting user a selection of a preferred experienced user. The system 30 may then send the user help request at block 114 to the selected, experienced user.

An embodiment consistent with the invention may receive acceptance from the experienced user indicating their willingness to share instructional information with the requesting user. Should the experienced user alternatively decline sharing the instructional information at block 116, the requesting user may be notified and prompted to select another candidate at block 112.

Embodiments consistent with the invention may facilitate communication at block 118 of the instructional information from the experienced, willing user to the requesting user. Facilitating efforts may include automatically passing contact information and/or providing a conduit, e.g., electronic mail, voice link, etc., between the requesting and experienced users.

Those skilled in the art will further recognize that the exemplary environments illustrated in FIGS. 1-6 are not intended to limit the present invention. Indeed, those skilled in the art will recognize that other alternative hardware and/or software environments may be used without departing from the scope of the invention.

Moreover, while the present invention has been illustrated by a description of various embodiments and while these embodiments have been described in considerable detail, it is not the intention of the Applicants to restrict, or in any way limit the scope of the appended claims to such detail. The invention in its broader aspects is therefore not limited to the specific details, representative apparatus and method, and illustrative example shown and described. Accordingly, departures may be made from such details without departing from the spirit or scope of Applicants' general inventive concept.

What is claimed is:

1. A computer-implemented method of facilitating the communication of instructional information relating to a computer function, the computer-implemented method comprising:
automatically determining in response to a user request for the instructional information an experienced user based upon usage of the computer function by the experienced user; and
facilitating communication of the instructional information from the experienced user to the requesting user.

2. The computer-implemented method of claim 1, further comprising automatically recording usage data associated with the usage of the computer function by the experienced user.

3. The computer-implemented method of claim 1, further comprising defining a group comprising at least the experienced user from which the experienced user is automatically selected.

4. The computer-implemented method of claim 1, wherein determining the experienced user further comprises determining the usage of the computer function by the experienced user.

5. The computer-implemented method of claim 1, wherein determining the experienced user further comprises determining the usage of the computer function by the experienced user based upon a frequency of use of the computer function by the experienced user.

6. The computer-implemented method of claim 1, wherein determining the experienced user further comprises determining the usage of the computer function by the experienced user based upon how recently the experienced user has accessed the computer function.

7. The computer-implemented method of claim 1, wherein determining the experienced user further comprises determining a proximity of the experienced user to the requesting user.

8. The computer-implemented method of claim 1, wherein determining the experienced user further comprises determining a relative availability of the experienced user and other criteria.

9. The computer-implemented method of claim 1, further comprising receiving the request for the instructional information from the requesting user.

10. The computer-implemented method of claim 1, further comprising querying a database including usage data pertaining to the usage of the computer function by the experienced user.

11. The computer-implemented method of claim 1, further comprising displaying to the user requesting the instructional information results data comprising at least the experienced user.

12. The computer-implemented method of claim 11, further comprising prompting a selection of the results data by the user requesting the instructional information to the display.

13. The computer-implemented method of claim 1, wherein facilitating the communication of the instructional information further comprises communicating contact information to at least one of the experienced user and the user requesting the instructional information.

14. The computer-implemented method of claim 1, wherein facilitating the communication of the instructional information further comprises communicating the instructional information to the user requesting the instructional information by using a communication mechanism selected from a list consisting of at least one of: electronic mail, instant messaging, voice chat, electronic data transfer, telephone-based and web-based communications.

15. The computer-implemented method of claim 1, wherein facilitating the communication of the instructional information further comprises enabling the experienced user to accept an invitation to provide the requested instructional information.

16. The computer-implemented method of claim 1, wherein facilitating the communication of the instructional information further comprises enabling the experienced user to decline providing instructional information.

17. The computer-implemented method of claim 16, further comprising prompting the selection of another experienced user.

18. An apparatus, comprising:
a memory;
program code residing in the memory; and
a processor in communication with the memory and configured to execute the program code to determine in response to a user request for instructional information pertaining to a computer function an experienced user based upon usage of the computer function by the experienced user, and to facilitate communication of the instructional information from the experienced user to the requesting user.

19. The apparatus of claim 18, wherein the memory further comprises a database storing usage data associated with the usage of the computer function by the experienced user.

20. A program product, comprising:
program code configured to determine in response to a user request for instructional information pertaining to a computer function an experienced user based upon usage of the computer function by the experienced user, and to facilitate communication of the instructional information from the experienced user to the requesting user; and
a computer readable medium bearing the program code.
